(19) United States
(12) Patent Application Publication
(10) Pub. No.: US 2010/0229759 A1
(43) Pub. Date: Sep. 16, 2010

(54) METHOD OF PRODUCING WHITE PIGMENT DISPERSION LIQUID AND METHOD OF PRODUCING INKJET RECORDING MEDIUM

(75) Inventor: Ryoichi NAKANO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/720,692

(22) Filed: Mar. 10, 2010

(30) Foreign Application Priority Data
Mar. 13, 2009 (JP) 2009-061343

(51) Int. Cl. C09C 1/28; C09C 3/00; C08L 79/02

(52) U.S. Cl. 106/489; 106/400; 106/499; 524/538

(57) ABSTRACT

A method of producing a white pigment dispersion liquid includes: mixing and dispersing a white pigment, a dispersant and a medium to form a dispersion liquid in which the amount of the white pigment is 20% by mass or more relative to the total mass of the dispersion liquid; and subjecting the dispersion liquid to a depressurization treatment after the dispersing. A method of producing an inkjet recording medium includes: producing a white pigment dispersion liquid by the method of producing a white pigment dispersion liquid; preparing a coating liquid by mixing at least the white pigment dispersion liquid and a water-soluble resin; and forming an ink receiving layer by applying the coating liquid onto a support.

### CROSS-REFERENCE TO RELATED APPLICATION

This Application claims priority under 35 USC 119 from Japanese Patent Application No. 2009-061343, filed on Mar. 13, 2009, the disclosure of which is incorporated by reference herein.

### BACKGROUND OF THE INVENTION

1. Field of Invention

The present invention relates to a method of producing a white pigment dispersion liquid and a method of producing an inkjet recording medium using the white pigment dispersion liquid.

2. Description of the Related Art

An inorganic fine particle dispersion liquid can be prepared, for example, by mixing and dispersing silica fine particles in a medium (dispersion medium) such as water, an organic solvent or a mixture thereof, or by mixing silica fine particles with a medium, subjecting the resultant mixture to a first dispersion (premixing) to form a fine particle slurry, and thereafter subjecting the fine particle slurry to a second dispersion using a dispersing machine such as a sand mill or a ball mill.

For a pigment dispersion liquid in which inorganic pigment particles such as silica particles are dispersed, the stability of the dispersed state of the dispersion liquid (dispersion stability) is important. However, pigment particles have a tendency to aggregate in a liquid, thereby increasing viscosity. The increase in viscosity tends to become more pronounced as the pigment concentration in the liquid increases. In the conventional art, a technique whereby a stable dispersed state and viscosity are maintained in a liquid containing pigment particles at high concentration has not yet been established.

For example, in inkjet recording paper used for inkjet recording, inorganic particles are often used in a layer on which ink droplets are deposited, and, in general, the layer is formed by applying, to a support, a coating liquid for a layer-formation in which inorganic particles are dispersed and contained. When the coating liquid containing inorganic particles is in an unstable dispersed state, the inorganic particles tend to aggregate and the viscosity of the liquid tends to change. Occurrence of the aggregation or the viscosity increase not only results in coating defects such as cissing defects or streak-like defects in a coating layer, but also in deterioration of properties such as image density, glossiness or ink absorptivity.

Accordingly, techniques for improving the dispersibility and the dispersion stability of inorganic particles, including silica particles, have been extensively studied.

As a technique related to the above, a technique whereby dispersion is performed at reduced pressure using a pigment dispersing apparatus which includes a container having a structure capable of reducing pressure, a dispersing mechanism and a media mill capable of reducing the pressure at a portion where a solid pigment is dispersed in a liquid medium, and which further has a mechanism that continuously circulates a mixture of the solid pigment and the liquid medium between the container and the dispersing mechanism has been disclosed (see, for example, Japanese Patent Application Laid-Open (JP-A) No. 2000-351916).

Further, a method of producing a pigment dispersion liquid has been disclosed in which, after a mixture containing at least a pigment, a liquid medium and a dispersant has been maintained under reduced pressure, the mixture is held at a pressure not lower than ordinary pressure, and the mixture is subsequently subjected to a dispersing treatment (see, for example, JP-A No. 2002-69325).

Furthermore, a method is disclosed which includes suctioning and accelerating fine particles using a vacuum and, simultaneously thereto, mixing and dispersing the fine particles in a liquid (see, for example, JP-A No. 2004-216687).

### SUMMARY OF THE INVENTION

Even when conventional methods are used, an increase in the pigment concentration (in terms of solid concentration) in a pigment dispersion liquid inevitably causes a viscosity increase. Therefore, when the solid concentration is high, such as with a pigment concentration of 20% by mass, it has been difficult to achieve the desired dispersion properties and stability after dispersing without causing changes in viscosity.

The present invention has been made in view of the above circumstances and provides a method of producing a white pigment dispersion liquid and a method of producing an inkjet recording medium.

According to a first aspect of the invention, there is provided a method of producing a white pigment dispersion liquid including: mixing and dispersing a white pigment, a dispersant and a medium to form a dispersion liquid in which the amount of the white pigment is 20% by mass or more relative to the total mass of the dispersion liquid; and subjecting the dispersion liquid to a depressurization treatment after the dispersing.

According to a second aspect of the invention, there is provided a method of producing an inkjet recording medium including: producing a white pigment dispersion liquid by the method of producing a white pigment dispersion liquid according to the first aspect of the invention; preparing a coating liquid by mixing at least the white pigment dispersion liquid and a water-soluble resin; and forming an ink receiving layer by applying the coating liquid onto a support.

### DETAILED DESCRIPTION OF THE INVENTION

Hereinafter, a method of producing a white pigment dispersion liquid of the invention and a method of producing an inkjet recording medium of the invention are described in detail.

<Method of Producing White Pigment Dispersion Liquid>

The method of producing a white pigment dispersion liquid according to the invention includes a process of mixing and dispersing a white pigment, a dispersant and a medium to form a dispersion liquid, in which the amount of the white pigment is 20% by mass or more relative to the total mass of the dispersion liquid (hereinafter referred to as a “dispersing process”) and a process of subjecting the dispersion liquid to a depressurization treatment (hereinafter referred to as a “depressurization process”) after the dispersing. The method of producing a white pigment dispersion liquid of the invention may include another process, if necessary.

In the invention, when a white pigment contained at a high ratio of 20% by mass or more with respect to the total mass of the dispersion liquid to be formed is subjected to a dispersing treatment, a depressurization treatment is performed after the dispersing treatment rather than during or before the dispersing treatment, as a result of which the dispersibility of the white pigment can be maintained even when the concentration of the white pigment is high, and the pigment concentration (in terms of solid concentration) of the pigment dispersion liquid can be increased while suppressing an increase in the liquid viscosity.

—Dispersing Process—

In the dispersing process in the invention, a white pigment, a dispersant and a medium are mixed and dispersed, wherein the amount of the white pigment is 20% by mass or more with respect to the total mass of the dispersion liquid. In the invention, favorable dispersibility can be achieved and an increase in viscosity can be suppressed even when the concentration of the white pigment (in terms of solid concentration) is as high as 20% by mass or more.

When performing the dispersing treatment, in addition to the white pigment, the dispersant and the medium, other ingredients may be added and mixed. The dispersing treatment may be performed using a known dispersing method. For example, the dispersing treatment may be performed using a known dispersing machine such as a high-speed rotation dispersing machine, a medium agitation dispersing machine (such as a ball mill or a sand mill), an ultrasonic dispersing machine, a colloid mill dispersing machine or a high-pressure dispersing machine. A medium agitation dispersing machine, a colloid mill dispersing machine or a high-pressure dispersing machine is preferred from the viewpoint of performing the dispersing treatment efficiently.

The dispersing conditions such as the revolution or agitation speed and the processing time for the dispersing treatment may be suitably selected considering the composition or the dispersing machine to be used.

<White Pigment>

At least one white pigment is used when performing the dispersing treatment in the dispersing process. The white pigment is used in an amount that is 20% by mass or more with respect to the total mass of the dispersion liquid obtained by the dispersing treatment.

The ratio of the white pigment to the total mass of the dispersion liquid of the invention is 20% by mass or more, and a higher pigment concentration is preferred. The ratio is preferably 25% by mass or more, and more preferably in the range of from 25% by mass to 35% by mass.

Examples of the white pigment include silica fine particles (such as vapor-phase process silica particles or hydrous silica particles), colloidal silica, titanium dioxide, barium sulfate, calcium silicate, zeolite, kaolinite, halloysite, mica, talc, calcium carbonate, magnesium carbonate, calcium sulfate, boehmite and pseudoboehmite. In particular, pigments synthesized from silicon tetrachloride are preferred, silica fine particles are particularly preferred and vapor-phase process silica is still more preferred.

Since the silica fine particles have a very large specific surface area, the ink absorptivity and ink retaining capability are high. Since the silica fine particles have a low refractive index, transparency can be imparted to a layer formed using the silica fine particles that have been dispersed to a suitable particle diameter, whereby a high color density and favorable color-forming property can be achieved. The transparency of an ink-receiving layer is important in applications in which transparency is required such as applications to an OHP, as well as when applied to recording sheets such as photo glossy paper in the light of obtaining a high color density and favorable coloring gloss.

Silica particles are roughly classified into wet process particles and dry process particles, depending on the production method thereof.

A common dry process (vapor-phase process) is a method of obtaining anhydrous silica (vapor-phase process silica) by a process employing vapor-phase hydrolysis of a silicon halide at high temperatures (flame hydrolysis method), or by a process of reducing and vaporizing silica sand by heating using coke and an arc in an electric furnace and oxidizing the resultant with air (arc method). A common wet method is a method of obtaining hydrous silica by forming active silica by acidolysis of a silicate, polymerizing the active silica and allowing the resultant to aggregate and sediment. The hydrous silica particles and the anhydrous silica particles obtained by these methods are different, for example, in the density of silanol groups on the surface thereof and/or in the presence or the absence of voids; thus, the hydrous silica particles exhibit different characteristics from those of the anhydrous silica particles. However, since anhydrous silica (silicic anhydride) easily forms a three-dimensional structure with a particularly high porosity, anhydrous silica is particularly preferred. Although the reason is not clear, it is presumed that the density of silanol groups on the surface of the anhydrous silica fine particles is as high as 5 groups/nm² to 8 groups/nm², as a result of which the silica fine particles tend to aggregate densely. On the other hand, since the density of silanol groups on the surface of the anhydrous silica fine particles is as low as 2 groups/nm² to 3 groups/nm², the silica particles tend to form sparse flocculates, as a result of which the structure with a high porosity is formed.

Accordingly, in the invention, the anhydrous silica (vapor-phase process silica having a density of silanol groups on the surface of the fine particles of from 2 groups/nm² to 3 groups/nm²) obtained by the vapor-phase process is preferred.

When the silica fine particles are used, the particles easily adhere together through hydrogen bonding of the silanol groups on the surface of the particles. Therefore, a porous structure with high porosity can be formed when the average primary diameter of the silica particles is 50 nm or less, preferably 30 nm or less. When forming an ink receiving layer, such an average primary diameter is favorable in that the ink absorptivity improves effectively.

The average primary diameter of the particles of the white pigment in the invention is preferably 20 nm or less. When the ratio of the mass of white pigment with respect to the total mass of the dispersion liquid is 20% by mass or more as described above, an average primary particle diameter of the white pigment of 20 nm or less tends to result in aggregation of the particles during or after dispersing; however, the aggregation of the pigment particles and the increase in the liquid viscosity are remarkably suppressed according to the invention. The average primary diameter of the white pigment is preferably in the range of from 3 nm to 20 nm, and is more preferably from 3 nm to 10 nm from the viewpoint of the transparency of a film prepared using the white pigment. The value of the average primary diameter of the white pigment is a value measured using a transmission electron microscope (TEM).

In the invention, it is preferable that the vapor-phase process silica having an average primary diameter of from 3 nm to 20 nm is used at an amount of 25% by mass or more with respect to the dispersion liquid since effects in suppression of the aggregation of the pigment particles and suppression of the increase in the liquid viscosity are more conspicuous.

The vapor-phase process silica having a specific surface area of 200 m²/g or more as measured by the BET method is preferred, because a layer which has a high porosity and an excellent ink absorptivity can be easily formed when the pigment dispersion liquid is applied after dispersing.

The BET method is a method of measuring a specific surface area described in, for example, Technical Document No. 10-2, 2 of Nippon Aerosil Co., Ltd. The BET method is a method of measuring the surface area of powder employing a gas-phase adsorption method, and the total surface area per one gram of a specimen, namely the specific surface area, is obtained from the adsorption isotherm. A widely-used gas to be adsorbed (adsorption gas) is nitrogen gas. A most common method is a method whereby the adsorption amount is measured from a change in the pressure or volume of the absorption gas. A most well-known expression that expresses an isotherm of a multimolecular adsorption is the equation of Brunauer, Emmett and Teller (BET equation), which is widely used for determining the surface area. The gas adsorption amount is obtained based on the BET equation, and the surface area can be determined by multiplying the adsorption amount by the surface area occupied by one adsorption molecule.

The specific surface area of the vapor-phase process silica calculated according to the BET method is preferably 220 m²/g or more, and is particularly preferably 300 m²/g or more.

<Dispersant>

At least one dispersants is used for the dispersing treatment in the dispersing process. The white pigment, the below-described medium and a dispersant are mixed, and the resultant mixture liquid is dispersed by a dispersing machine such that the fine particles of the white pigment are dispersed in the mixture liquid, whereby a dispersion liquid is obtained.

In an embodiment, an aqueous dispersion liquid of the white pigment is prepared in advance, and the aqueous dispersion liquid is added to an aqueous solution of a dispersant. In another embodiment, an aqueous solution of a dispersant is added to an aqueous dispersion liquid of the white pigment. In still another embodiment, the white pigment and the dispersant is mixed at one time. To the aqueous solution of a dispersant, the white pigment may be added in a powdery state in a manner similar to the above, rather than in the form of the aqueous dispersion liquid of the white pigment.

The dispersant may be a cationic compound. The cationic compound is preferable in that bleeding of the recorded image may be suppressed and a white pigment (preferably a vapor-phase process silica) may be dispersed. It is preferable to use a cationic polymer as the dispersant, and examples of the cationic polymer include the mordants described in JP-A No. 2006-321176, paragraphs [0138] to [0148]. Alternatively, the use of a silane coupling agent as the dispersant is also preferable.

Specifically, a polymer having a primary amino group, a secondary amino group, a tertiary amino group or a quaternary ammonium base is preferable as the cationic polymer. Examples of the cationic polymer include a nitrogen-containing organic cationic polymer that is a homopolymer of a monomer having a primary to tertiary amino group or a salt thereof or a quaternary ammonium salt group (nitrogen-containing organic cationic monomer), a nitrogen-containing organic cationic polymer obtained as a copolymer or condensate of the above nitrogen-containing organic cationic monomer and one or more other monomers, and a nitrogen-containing organic cationic polymer obtained by cationizing, by using a compound containing a cationic group, any of the following: a conjugate diene copolymer such as a styrene-butadiene copolymer or a methyl methacrylate-butadiene copolymer; an (meth)acrylic polymer such as a polymer or copolymer of an acrylic ester or a methacrylic ester, or a polymer or copolymer of acrylic acid or methacrylic acid; a styrene-(meth)acrylic polymer such as a styrene-acrylic ester copolymer or a styrene-methacrylic ester copolymer; a vinyl polymer such as an ethylene-vinyl acetate copolymer; or an urethane polymer having urethane bonds.

Among them, from the viewpoint of dispersibility of the white pigment, a diallyldimethyl cationic polymer is preferred. Specific preferable examples thereof include polydiallyldimethylammonium chloride and polymethacryloyloxyethyl-β-hydroxyethyl dimethylammonium chloride derivative; polydiallyldimethylammonium chloride is more preferred. Examples of commercially available products include SHAROL DC902P (trade name) manufactured by Dai-ichi Kogyo Seiyaku Co., Ltd.

The ratio of the dispersant to the white pigment is preferably from 0.1% by mass to 30% by mass, and more preferably 1% by mass to 10% by mass.

In the method of producing a white pigment dispersion liquid of the invention, a crosslinking agent, such as boric acid for crosslink-curing the below-described water-soluble resin, may be incorporated. However, effects in the suppression of viscosity increase are strong when the post-dispersing depressurization treatment is performed in a system free of crosslinking agent, and are particularly strong when the pigment concentration in terms of solid concentration is increased. The amount of the crosslinking agent to be incorporated when dispersing is preferably 10% by mass or less with respect to the total mass of the dispersion liquid.

Each of the white pigment and the dispersant can be added in more than one stage. By adding in more than one stage, an abrupt increase in the viscosity of the liquid being dispersed can be suppressed, and the content ratio of the white pigment can be easily increased, so that the dispersion properties of the dispersion liquid with a high pigment concentration (in terms of solid concentration) can be improved.

When adding in more than one stage, the desired total addition amount may be divided into from about two to about five portions, and the portions may be added separately.

<Solvent>

The medium that is used as a dispersion medium in the dispersing treatment may be an aqueous medium. Examples of aqueous media that may be used include water, and a mixture of water and at least one organic solvent which is miscible with water. Examples of the organic solvent include alcohols such as methanol, ethanol, n-propanol, i-propanol and methoxypropanol, ketones such as acetone and methyl ethyl ketone, tetrahydrofuran, acetonitrile, ethyl acetate and toluene.

—Depressurization Process—

The depressurization process in the invention is a process of maintaining a treatment liquid, which has been subjected to the dispersing treatment in the dispersing process, in a reduced-pressure environment. Here, the expression “maintaining” means a state in which the treatment liquid (dispersion liquid) after the completion of the dispersing treatment is subjected to only an agitation treatment that involves circulation or the like. This agitation treatment is different from the agitation that is performed when the dispersing treatment is carried out, and means an agitation for maintaining the dispersion liquid in a fluid state.

When the white pigment and the dispersant are added all at once and are subjected to the dispersing treatment in the dispersing process, the treatment liquid after the dispersing treatment may be subjected to the depressurization process. When the addition and mixing of each of the white pigment and the dispersant is performed in more than one stage, the depressurization process may be performed, at least one point of time in the addition sequence, on the treatment liquid to which a part of the white pigment and the dispersant has been added and dispersed in the course of the dispersing treatment, and/or on the final treatment liquid to which the total amount of each of the white pigment and the dispersant has been added. It is preferable that, every time a part of the white pigment and a part of the dispersant are added and the dispersing treatment is performed, the depressurization process is carried out after every dispersing treatment.

In regard to the depressurization condition, it is preferable to reduce the pressure by at least 1.0×10⁴ Pa (i.e., to a pressure of (atmospheric pressure −1.0×10⁴ Pa) or lower) from the viewpoint of enhancing the effect of suppressing an increase in viscosity when dispersing and increasing the content ratio of the white pigment having a small particle diameter of preferably 20 nm or less (for example, vapor-phase process silica having a small particle diameter of preferably 20 nm or less) (to preferably 25% by mass or more). Especially, from the same viewpoints as above, it is preferable to reduce the pressure such that the reduced pressure is in the range of from (atmospheric pressure −2.0×10⁴ Pa) to (atmospheric pressure −10×10⁴ Pa), and particularly preferably in the range of from (atmospheric pressure −4.0×10⁴ Pa) to (atmospheric pressure −10×10⁴ Pa).

The duration of the depressurization treatment varies with the degree of depressurization, and is preferably 3 minutes or more, and more preferably from 4 minutes to 120 minutes, under the depressurization conditions as described above. In particular, the depressurization treatment is preferably performed at a reduced pressure of from (atmospheric pressure −2.0×10⁴ Pa) to (atmospheric pressure −10×10⁴ Pa) for from 5 to 60 minutes. A treatment time within the above range provides sufficient effects of the depressurization, is effective in the suppression of an increase in viscosity.

The method of the depressurization is not specifically restricted, and may be selected from known methods such as suctioning and evacuation using, for example, a pump.

The dispersing process and the depressurization process in the invention can be suitably performed by using PSI-MIX•MICRO PSI (trade name) manufactured by Ashizawa Finetech Ltd., for example.

<Method of Producing Inkjet Recording Medium>

The method of producing an inkjet recording medium of the invention is a method in which the method of producing a white pigment dispersion liquid of the invention is utilized. More specifically, the method of producing an inkjet recording medium of the invention includes producing the white pigment dispersion liquid according to the method of producing a white pigment dispersion liquid of the invention (hereinafter referred to as a “pigment dispersion liquid production process”), preparing a coating liquid by mixing at least the prepared white pigment dispersion liquid and a water-soluble resin (hereinafter referred to as a “coating liquid preparation process”), and forming an ink receiving layer by applying the prepared coating liquid onto a support (hereinafter referred to as an “ink receiving layer formation process”). The method of producing an inkjet recording medium of the invention may include another process, if necessary.

In the method of producing an inkjet recording medium of the invention, since the white pigment dispersion liquid having a moderate viscosity and a high solid concentration, which is prepared by the method of producing a white pigment dispersion liquid as described above, is used, coating defects can be suppressed, and an inkjet recording medium having an inkjet recoding layer having favorable properties in image density, glossiness and ink absorptivity can be produced.

—Pigment Dispersion Liquid Production Process—

In the pigment dispersion liquid production process, a white pigment dispersion liquid is produced according to the method of producing a white pigment dispersion liquid of the invention described above. Details of the production of the white pigment dispersion liquid are as described above.

—Coating Liquid Preparation Process—

In the coating liquid preparation process, a coating liquid is prepared by mixing at least the white pigment dispersion liquid prepared through the pigment dispersion production process and a water-soluble resin. When preparing the coating liquid, at least one of a crosslinking agent for crosslinking the water-soluble resin, a mordant, a water-soluble polyvalent metal salt or other components may be added in addition to the white pigment dispersion liquid and the water-soluble resin, if necessary.

<Water-Soluble Resin>

Examples of the water-soluble resin include resins having a hydroxyl group as a hydrophilic structural unit, such as polyvinyl alcohol resins (for example, polyvinyl alcohol (PVA), acetoacetyl-modified polyvinyl alcohol, cation-modified polyvinyl alcohol, anion-modified polyvinyl alcohol, silanol-modified polyvinyl alcohol, and polyvinyl acetal), cellulose resins (for example, methyl cellulose (MC), ethyl cellulose (EC), hydroxyethyl cellulose (HEC), carboxymethyl cellulose (CMC), hydroxypropyl cellulose (HPC), hydroxyethylmethyl cellulose, and hydroxypropylmethyl cellulose), chitins, chitosans and starch; resins having an ether bond (for example, polyethylene oxide (PEO), polypropylene oxide (PPO), polyethylene glycol (PEG), and polyvinyl ether (PVE)); and resins having a carbamoyl group (for example, polyacrylamide (PAAM), polyvinyl pyrrolidone (PVP), and polyacrylic acid hydrazide).

Further examples of the water-soluble resin include resins having a carboxyl group as a dissociative group, such as salts of polyacrylic acid, maleic acid resins, salts of alginic acid and gelatins.

In particular, the water-soluble resin is preferably at least one resin selected from a polyvinyl alcohol resin, a cellulose resin, a resin having an ether bond, a resin having a carbamoyl group, a resin having a carboxyl group, or gelatin, and is more preferably a polyvinyl alcohol (PVA) resin.

The polymerization degree of the water-soluble resin is preferably 1,800 or more, and more preferably from 2,000 to 4,000. When the polymerization degree is 1,800 or more, favorable ink absorptivity can be achieved.

The content of the water-soluble resin is preferably from 9% by mass to 40% by mass, and more preferably from 16% by mass to 33% by mass, with respect to the total solid content of the coating liquid or of the ink receiving layer. When the content is 9% by mass or more, an excellent layer strength can be obtained, and when the content is 40% by mass or less, the voids are not easily clogged with the resin, as a result of which a high ink absorptivity can be maintained.

The water-soluble resin that is contained, together with the white pigment, in the coating liquid may be a single material or a mixture of plural materials.

The kind of the water-soluble resin used in combination with, for example, the vapor-phase process silica is important from the viewpoint of imparting transparency. When the vapor-phase process silica is used, the water-soluble resin used therewith is preferably a polyvinyl alcohol resin, more preferably a polyvinyl alcohol resin having a saponification degree of from 70% to 100%, and particularly preferably a polyvinyl alcohol resin having a saponification degree of from 80% to 99.5%.

Polyvinyl alcohol resins have hydroxyl groups in structural units thereof, and hydrogen bonds are formed between these hydroxyl groups and silanol groups present on the surfaces of the vapor-phase process silica, as a result of which a three-dimensional network structure having secondary particles of the vapor-phase process silica as network chain units is easily formed. It is thought that the formation of such a three-dimensional network structure allows the ink receiving layer formed to have a porous structure with a high porosity and a sufficient strength. When inkjet recording is performed, the porous ink receiving layer formed in the foregoing manner quickly absorbs ink through capillary action, and dots of high circularity without ink bleeding can be formed.

The polyvinyl alcohol resin may be used in combination with one or more other water-soluble resins such as those described above. When other water-soluble resins are used in combination with the polyvinyl alcohol resin, the content of the polyvinyl alcohol resin is preferably 50% by mass or more, and more preferably 70% by mass or more, with respect to the total mass of water-soluble resins.

˜Ratio of Vapor-Phase Process Silica Content to Water-Soluble Resin Content˜

By optimization of the ratio of the vapor-phase process silica content (x) by mass to the water-soluble resin content (y) by mass [PB ratio (x/y)], the film structure and film strength of the ink receiving layer can further be enhanced.

In the invention, the PB ratio (x/y) of the ink receiving layer is preferably in a range of from 1.5/1 to 10/1 from the viewpoints of preventing a decrease in film strength and the cracks while drying caused by excessively high PB ratios, and avoiding a reduction in ink absorbency due to decrease in porosity caused by an increased tendency for pores to be clogged by the resins which results from excessively low PB ratios.

When passing through the transport system of an inkjet printer, the recording medium is subjected to stress in some cases; therefore, the ink receiving layer preferably has sufficient film strength. The sufficient strength of the ink receiving layer is favorable also from the standpoint of avoiding the occurrence of cracking and detachment of the ink receiving layer when the recording medium is cut into sheets. In view of these cases, the mass ratio (x/y) is preferably 5/1 or less, while it is preferably 2/1 or more from the viewpoint of ensuring capability of high-speed ink absorption in inkjet printers.

For example, when a coating liquid prepared by completely dispersing vapor-phase process silica particles having an average primary particle diameter of 20 nm or less and a water-soluble resin at a mass ratio (x/y) of from 2/1 to 5/1 in a solution is applied onto a support and the resultant coating layer is dried, a three-dimensional network structure is formed which has secondary particles of the vapor-phase process silica as network chains, whereby a light-transmitting porous film having an average pore diameter of 30 nm or less, a porosity of from 50% to 80%, a specific pore volume of 0.5 ml/g or more, and a specific surface area of 100 m²/g or more can be easily formed.

<Crosslinking Agent>

With a view to crosslinking the water-soluble resin, the coating liquid in the invention may contain at least one crosslinking agent.

The ink receiving layer may be a porous layer, and the porous layer can be formed by using a combination of the white pigment and the water-soluble resin and curing the water-soluble resin through crosslinking reaction with the crosslinking agent.

In the invention, the content of the crosslinking agent in the coating liquid is preferably from 1% by mass to 50% by mass, and more preferably from 5% by mass to 40% by mass, with respect to the water-soluble resin. The crosslinking agent is preferably added after producing the white pigment dispersion liquid, and the coating liquid for forming an ink receiving layer can be prepared using the crosslinking agent. The crosslinking agent may be used singly or may be used in combination of two or more kinds thereof.

A boron compound is preferable for crosslinking the water-soluble resin, particularly, for crosslinking a polyvinyl alcohol resin.

Examples of the boron compound include borax, boric acid, and borates (for example, orthoborate, InBO₃, ScBO₃, YBO₃, LaBO₃, Mg₃(BO₃)₂ and CO₃(BO₃)₂), diborates (for example, Mg₂B₂O₅ and CO₂B₂O₅), metaborates (for example, LiBO₂, Ca(BO₂)₂, NaBO₂ and KBO₂), tetraborates (for example, Na₂B₄O₇.10H₂O), pentaborates (for example, KB₅O₈.4H₂O and CsB₅O₅), and hexaborates (for example, Ca₂B₆O₁₁.7H₂O). Among them, from the viewpoint of causing a rapid crosslinking reaction, borax, boric acid and a borate are preferable, and boric acid is particularly preferable.

Examples of crosslinking agents include, other than the boron compounds, the following compounds: aldehyde compounds, such as formaldehyde, glyoxal and gultaraldehyde; ketone compounds, such as diacetyl and cyclopentanedione; active halogen compounds, such as bis(2-chloroethylurea)-2-hydroxy-4,6-dichloro-1,3,5-triazine and sodium salts of 2,4-dichloro-6-s-triazine; active vinyl compounds, such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins; isocyanate compounds, such as 1,6-hexamethylene diisocyanate; the aziridine compounds described in U.S. Pat. Nos. 3,017,280 and 2,983,611; the carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate and chromium acetate; polyamine compounds, such as tetraethylenepentamine; hydrazide compounds, such as adipic acid dihydrazide; and low-molecular compounds or polymers each having at least two oxazoline groups.

<Mordant>

The coating liquid of the invention may further contain at least one mordant in addition to the dispersant added to the white pigment dispersion liquid. The inclusion of the mordant effectively prevents ink bleed in a formed image and bleeding with the passage of time, and further improves water resistance.

The mordant to be used may be a cationic polymer (cationic mordant). The cationic mordant to be used is preferably a polymer mordant having a primary, secondary or tertiary amino group or having a quaternary ammonium salt group as a cationic group. Examples of mordants that may be used further include a cationic non-polymer mordant.

Preferable examples of polymer mordants include a homopolymer of a monomer (mordant monomer) having a primary, secondary or tertiary amino group or a salt thereof, or having a quaternary ammonium salt group, and a copolymer or polycondensate of a mordant monomer with at least one other monomer (hereinafter referred to as a “non-mordant monomer”). Further, the polymer mordant may be used either as a water-soluble polymer or water-dispersible latex particles.

Examples of the monomer (the mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N2-(4-vinylphenyl)ethylammonium chloride, N,N,N-triethyl-N2-(3-vinylphenyl)ethylammonium chloride, N,N-diethyl-N-methyl-N2-(4-vinylphenyl)ethylammonium chloride, N,N-diethyl-N-methyl-N2-(4-vinylphenyl)ethylammonium acetate, quaternarized products prepared by reacting N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide or N,N-diethylaminopropyl (meth)acrylamide with methyl chloride, ethyl chloride, methyl bromide, ethyl bromide, methyl iodide or ethyl iodide, and sulfonates, alkylsulfonates, acetates or alkylcarboxylates obtained by anion substitution of these quaternarized products.

The non-mordant monomer may be a monomer which does not have a basic or cationic moiety such as a primary, secondary or tertiary amino group or a salt thereof or a quaternary ammonium salt group, and which shows no interaction with, or substantially small interaction with, dyes in an inkjet ink. Examples of the non-mordant monomer include alkyl esters of (meth)acrylic acid; cycloalkyl esters of (meth)acrylic acid, such as cyclohexyl (meth)acrylate; aryl esters of (meth)acrylic acid, such as phenyl (meth)acrylate; aralkyl esters, such as benzyl (meth)acrylate; aromatic vinyl compounds, such as styrene, vinyltoluene and α-methylstyrene; vinyl esters, such as vinyl acetate, vinyl propionate and vinyl versatate; allyl esters, such as allyl acetate; halogen-containing monomers, such as vinylidene chloride and vinyl chloride; vinyl cyanides, such as (meth)acrylonitrile; and olefins, such as ethylene and propylene.

Preferable examples of the alkyl esters of (meth)acrylic acid include an alkyl (meth)acrylate of which alkyl moiety has from 1 to 18 carbon atoms, and specific examples thereof include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate. Among these, methyl acrylate, ethyl acrylate, methyl methacrylate, ethyl methacrylate and hydroxyethyl methacrylate are preferred. A single non-mordant monomer may be used, or two or more non-mordant monomers may be used in combination.

Further, examples of the polymer mordant include polydiallyldimethyl ammonium chloride, polymethacryloyloxyethyl-β-hydroxyethyldimethylammonium chloride, polyethyleneimine, polyallylamine, polyallylamine hydrochloride, polyamide-polyamine resin, cationized starch, dicyandiamide-formalin condensate, dimethyl-2-hydroxypropyl ammonium salt polymer, polyamidine, and polyvinylamine.

The molecular weight of the polymer mordant is preferably from 1,000 to 200,000, and more preferably from 3,000 to 40,000. When the molecular weight is 1,000 or more, the water-resistance is favorable, and when the molecular weight is 200,000 or less, the viscosity is not excessively high and handling properties are also favorable.

Preferable examples of cationic non-polymer mordants include water-soluble metal salts such as aluminum sulfate, aluminum chloride, polyaluminum chloride and magnesium chloride.

Among them, a polyallylamine having a molecular weight of from 3,000 to 40,000 is preferred since the use of the polyallylamine allows formation of an ink receiving layer having an excellent ink retention capacity, formation of a high definition image while suppressing ink bleed with the passage of time and stable retention of the image over a long period of time.

<Water-Soluble Polyvalent Metal Salt>

The coating liquid of the invention may include at least one water-soluble polyvalent metal compound as a mordant.

The water-soluble polyvalent metal compound is preferably a tri- or higher-valent metal compound. Examples of the tri- or higher-valent metal compound include water-soluble salts of metals selected from calcium, barium, manganese, copper, cobalt, nickel, aluminum, iron, zinc, zirconium, chromium, tungsten or molybdenum. Specific examples of the water-soluble salts of metals include calcium acetate, calcium chloride, calcium formate, calcium sulfate, calcium butyrate, barium acetate, barium sulfate, barium phosphate, barium oxalate, barium naphthoresorcinol dicarboxylic acid, barium butyrate, manganese chloride, manganese acetate, manganese formate dihydrate, ammonium manganese sulfate hexahydrate, cupric chloride, ammonium cupric chloride dihydrate, copper sulfate, cupric butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, nickel ammonium sulfate hexahydrate, nickel amidosulfate tetrahydrate, nickel sulfamate, nickel 2-ethylhexanoate, aluminum sulfate, aluminum sulfite, aluminum thiosulfate, polyaluminum chloride, aluminum nitrate nonahydrate, aluminum chloride hexahydrate, aluminum acetate, aluminum lactate, basic aluminum thioglycolate, ferrous bromide, ferrous chloride, ferric chloride, ferrous sulfate, ferric sulfate, ferric citrate, ferric lactate trihydrate, triammonium ferric trioxalate trihydrate, zinc bromide, zinc chloride, zinc nitrate hexahydrate, zinc sulfate, zinc acetate, zinc lactate, zirconium acetate, zirconium tetrachloride, zirconium chloride, zirconium dichloride oxide octahydrate, zirconium chloride hydroxide, chromium acetate, chromium sulfate, sodium phosphotungstate, sodium tungsten citrate, dodecatungstophosphate n-hydrate, dodecatungstosilicate 26-hydrate, molybdenum chloride, dodecamolybdophosphate n-hydrate, aluminum alum, basic polyaluminum hydroxide, zinc phenolsulfonate, ammonium zinc acetate and zinc ammonium carbonate.

Two or more water-soluble polyvalent metal compounds may be used in combination. The term “water-soluble” as used herein in connection with the water-soluble polyvalent metal compound in the invention means that the compound dissolves in water at 20° C. in an amount of 1% by mass or more.

Among the above-mentioned water-soluble polyvalent metal compounds, aluminum compounds or compounds which contain a metal belonging to group 4A of the periodic table (for example, zirconium, titanium or the like) are preferable, and aluminum compounds are more preferable. Water-soluble aluminum compounds are particularly preferable.

The water-soluble aluminum compound may be an inorganic salt such as a aluminum chloride or a hydrate thereof, aluminum sulfate or a hydrate thereof, or ammonium alum. Preferable examples of the water-soluble aluminum compound include a basic polyaluminum hydroxide compound, which is an inorganic aluminum-containing cationic polymer (hereafter sometimes referred to as basic polyaluminum chloride or polyaluminum chloride).

The term “basic polyaluminum hydroxide compound” described above refers to a water-soluble polyaluminum hydroxide of which main component is represented by the following Formula 1, 2 or 3, and which stably contains a basic polymeric polynuclear condensed ion, such as [Al₆(OH)₁₅]³⁺, [Al₈(OH)₂₀]⁴⁺, [Al₁₃(OH)₃₄]⁵⁺ or [Al₂₁(OH)₆₀]³⁺.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎, 0<m<3n Formula 3

Such basic polyaluminum hydroxide compounds are available from TAKI CHEMICAL CO., LTD. as a water treatment chemical under the trade name of POLYALUMINUM CHLORIDE (PAC), from Asada Chemical Industry Co., Ltd. under the trade name of POLYALUMINUM HYDROXIDE (Paho), from rikengreen Co., Ltd. under the trade name of HAP-25, from TAIMEI Chemicals Co., Ltd. under the trade name of ALFINE 83, or from other manufacturers as products for similar applications, and products of various grades are available.

Preferable examples of the water-soluble compounds containing a metal belonging to group 4A of the periodic table include titanium-containing water-soluble compounds and zirconium-containing water-soluble compounds. Examples of titanium-containing water-soluble compounds include titanium chloride, titanium sulfate, titanium tetrachloride, tetraisopropyl titanate, titanium acetylacetonate, and titanium lactate. Examples of a zirconium-containing water-soluble compound include zirconium acetate, zirconium chloride, zirconium hydroxychloride, zirconium nitrate, basic zirconium carbonate, zirconium hydroxide, zirconium lactate, ammonium zirconium carbonate, potassium zirconium carbonate, zirconium sulfate, and zirconium fluoride.

The content of the water-soluble polyvalent metal compound in the ink receiving layer is preferably from 0.1% by mass to 10% by mass, more preferably from 0.5% by mass to 8% by mass, with respect to the vapor-phase process silica.

<Other Components>

The coating liquid may contain various additives such as ultraviolet absorbers, antioxidants, or singlet oxygen quenchers, if necessary.

The coating liquid to be applied onto a support may be prepared in the following manner. For example, after the white pigment dispersion liquid is produced by the method of producing a white pigment dispersion liquid according to the invention, a crosslinking agent (for example, boric acid) and an aqueous solution of polyvinyl alcohol (PVA) (for example, in such an amount as to provide a PVA amount that is about ⅓ (by mass) of the vapor-phase process silica) are added. Further, to the resultant mixture, a water-soluble polyvalent metal salt (for example, a basic polyaluminum hydroxide compound) is added, and the resultant mixture is subjected to a dispersing treatment using a high-speed revolution wet colloid mill (for example, CLEAMIX (trade name) manufactured by M Technique Co., Ltd.), for example, under the conditions of a high-sped revolution of 10,000 rpm (preferably, from 5,000 to 20,000 rpm) for 20 minutes (preferably, from 10 to 30 minutes), as a result of which the coating liquid is obtained. The water-soluble polyvalent metal salt may alternatively be added by an in-line mixing immediately before applying the coating liquid.

The obtained coating liquid is in a homogeneous sol state, and a porous ink receiving layer having a three-dimensional network structure can be formed by applying the coating liquid onto a support by the following applying method and drying the applied coating liquid.

—Ink Receiving Layer Formation Process—

In the ink receiving layer formation process, the coating liquid prepared through the coating liquid preparation process is applied onto a support to form an ink receiving layer, thereby obtaining an inkjet recording medium. The inkjet recording medium may be configured to have at least an ink receiving layer on a support.

An ink receiving layer can be suitably formed according to the following first or second method of forming an ink receiving layer.

The first method of forming an ink receiving layer includes forming a coating layer by applying the coating liquid prepared by the coating liquid preparation process onto a support, and applying a basic solution containing a basic compound to the coating layer either (1) simultaneously with the application of the coating liquid or (2) during drying of the coating layer formed by applying the coating liquid but before the coating layer shows falling-rate drying, thereby curing the coating layer through crosslinking, as a result of which an ink receiving layer formed by curing the coating layer through crosslinking is obtained.

Further, the second method of forming an ink receiving layer includes forming a coating layer by applying the coating liquid prepared by the coating liquid preparation process onto a support, cooling the formed coating layer to a temperature that is at least 5° C. lower than the temperature of the coating liquid at the time of applying the coating liquid, and drying the cooled coating layer.

<Coating Layer Formation Process>

Each of the first and second methods includes a process of forming a coating layer by applying the coating liquid prepared by the coating liquid preparation process onto a support (which may be referred to as a “coating layer formation process” hereinafter). The application of the coating liquid can be performed using, for example, a known coating apparatus such as an extrusion die coater, an air doctor coater, a blade coater, a rod coater, a knife coater, a squeeze coater, a reverse roll coater, or a bar coater. The wet application amount of the coating liquid is preferably from 50 ml/m² to 200 ml/m² and more preferably from 75 ml/m² to 150 ml/m². The solid content application amount of the coating liquid is preferably from 5 g/m² to 25 g/m², and more preferably from 10 g/m² to 18 g/m².

The coating liquid contains at least the white pigment, the dispersant, the medium and the water-soluble resin as described above, and may further contain other components such as a crosslinking agent for crosslinking the water-soluble resin, a mordant or a surfactant, if necessary. Further, when applying the coating liquid, it is also preferable that the coating liquid is in-line mixed with a liquid containing the water-soluble polyvalent metal salt (preferably, basic polyaluminum chloride compound) and then applied.

The coating liquid is preferably acidic, and the pH thereof is preferably 5.0 or lower, more preferably 4.5 or lower, and further preferably 4.0 or lower. When the pH of the coating liquid is 5.0 or lower, crosslinking reaction of the water-soluble resin with a crosslinking agent (specifically a boron compound) in the coating liquid can be more strongly suppressed.

<Crosslink-Curing Process>

The first method includes a process of curing, through crosslinking, the coating layer formed through the coating layer formation process by applying a basic solution containing a basic compound at either (1) simultaneously with the application of the coating liquid or (2) during drying of the coating layer formed by the application of the coating liquid but before the coating layer shows falling-rate drying. Hereafter, this process is referred to as a crosslink-curing process.

The method of applying the basic solution “(1) simultaneously with the application of the coating liquid” is preferably a method of performing simultaneous multilayer coating of the coating liquid and the basic solution in this order from the support side. The simultaneous multilayer coating can be performed with a known coating apparatus, such as an extrusion die coater or a curtain flow coater.

A preferable method of applying the basic solution “(2) during drying of the coating layer formed by the application of the coating liquid but before the coating layer shows falling-rate drying” is the “Wet-On-Wet method” or “WOW method”. Details of “Wet-On-Wet method” are described, for example, in JP-A No. 2005-14593, paragraphs [0016] to [0037]. In the invention, the application of the basic solution can be carried out by, after the coating layer is formed by the application of the coating liquid, applying the basic solution during drying of the coating layer but before the coating layer shows falling-rate drying according to, for example, any one of (i) a method of applying the basic solution to the coating layer, (ii) a method of spraying the basic solution onto the coating layer using a spray or the like, or (iii) a method of immersing the support having the coating layer thereon in the basic solution.

The coating method for applying the basic solution in the method (i) include methods known in the art such as a coating method using a curtain flow coater, an extrusion die coater, an air doctor coater, a blade coater, a rod coater, knife coater, a squeeze coater, a reverse roll coater or a bar coater. Methods wherein the coater does not directly contact with the already-formed coating layer, such as methods using an extrusion die coater, a curtain flow coater, or a bar coater are preferable.

The expression “before the coating layer shows falling-rate drying” usually refers to a period of several minutes from immediately after the application of the coating liquid for forming an ink receiving layer (the coating liquid), and, during the period, the applied coating layer exhibits the phenomenon of “constant-rate drying” in which the solvent (dispersion medium) content in the applied coating layer decreases in proportion to the lapse of time. In regard to the period during which such “constant-rate drying” is observed, there are descriptions in, for example, Kagaku Kogaku Binran (Handbook of Chemical Technology), pages 707-712, MARUZEN Co., Ltd. (Oct. 25, 1980).

With respect to conditions for drying the coating layer until it comes to show falling-rate drying, the drying is performed generally at a temperature of from 40° C. to 180° C. for a period of from 0.5 minutes to 10 minutes (preferably from 0.5 minutes to 5 minutes). The drying time naturally varies with the coating amount, but the range specified above is usually appropriate.

In the following, the basic solution for use in the crosslink-curing process is described.

The basic solution for use in the invention contains at least one basic compound.

Examples of the basic compound include ammonium salts of weak acids, alkali metal salts of weak acids (such as lithium carbonate, sodium carbonate, potassium carbonate, lithium acetate, sodium acetate and potassium acetate), alkaline earth metal salts of weak acids (such as magnesium carbonate, barium carbonate, magnesium acetate and barium acetate), ammonium hydroxide, primary to tertiary amines (such as triethylamine, tripropylamine, tributylamine, trihexylamine, dibutylamine and butylamine), primary to tertiary anilines (such as diethylaniline, dibutylaniline, ethylaniline and aniline) and pyridines which may have a substituent (such as 2-aminopyridine, 3-aminopyridine, 4-aminopyridine and 4-(2-hydroxyethyl)-aminopyridine).

Any of the above basic compounds may be used in combination with another basic substance and/or a salt thereof. Examples of another basic substance include ammonia, primary amines such as ethylamine and polyallylamine, secondary amines such as dimethylamine, tertiary amines such as N-ethyl-N-methylbutylamine, hydroxides of alkali metals and hydroxides of alkaline earth metals.

Among them, an ammonium salt of a weak acid is particularly preferred. The weak acid may be an inorganic or organic acid having a pKa value of 2 or more, and are described in, for example, Handbook of Chemistry; Fundamental Volume II (published by Maruzen Co., Ltd.). Examples of the ammonium salts of weak acids include ammonium carbonate, ammonium hydrogen carbonate, ammonium borate, ammonium acetate and ammonium carbamate, but are not limited to them. Among them, ammonium carbonate, ammonium hydrogen carbonate and ammonium carbamate are preferred, and are effective in that these compounds do not remain in the layer after drying and the ink bleed can be reduced. The basic compound may be used in combination of two or more thereof.

The content of the basic compound (especially an ammonium salt of a weak acid) in the basic solution is preferably from 0.5% by mass to 10% by mass, and more preferably from 1% by mass to 5% by mass, with respect to total mass (including the solvent) of the basic solution. When the content of the basic compound (especially an ammonium salt of a weak acid) is adjusted to be in the foregoing range in particular, a sufficient degree of curing can be attained and impairment of a working environment caused by an excessively high ammonia concentration can be avoided.

The basic solution for use in the invention preferably contains at least one metal compound.

Any metal compound that is stable under basic conditions may be used, without particular limitations, as the metal compound to be incorporated in the basic solution. Specifically, any of the water-soluble polyvalent metal salts described above, metal complex compounds, inorganic oligomers and inorganic polymers may be used. More specifically, zirconium compounds and the compounds listed as inorganic mordants in JP-A No. 2005-14593, paragraphs [0100] and [0101] may be used. Examples of the metal complex compounds include the metal complexes described in Kagaku Sosetsu (Review of Chemistry), No. 32 (1981), edited by The Chemical Society of Japan, and the transition metal complexes containing transition metals such as ruthenium as described in Coordination Chemistry Review, vol. 84, pages 85-277 (1988), and JP-A No. 2-182701.

Among them, a zirconium compound and a zinc compound are preferred, and a zirconium compound is particularly preferred. Examples of the zirconium compound include ammonium zirconium carbonate, ammonium zirconium nitrate, potassium zirconium carbonate, ammonium zirconium citrate, zirconyl stearate, zirconyl octylate, zirconyl nitrate, zirconium oxychloride and zirconium chloride hydroxide. In particular, ammonium zirconium carbonate is preferred. Further, the basic solution may include two or more metal compounds (preferably including a zirconium compound) in combination.

The content of the metal compound (for example, a zirconium compound) in the basic solution is preferably from 0.05% by mass to 5% by mass, and more preferably from 0.1% by mass to 2% by mass, with respect to the total mass (including the solvent) of the basic solution. When the content of the metal compound (such as a zirconium compound) is adjusted to be in the foregoing range, the coating layer may be sufficiently cured, reduction in function as a mordant, which may prevent provision of sufficient print density and beading, may be prevented, and impairment of a working environment due to an excessive increase in the concentration of the basic compound such as ammonia may be prevented. In an embodiment, two or more metal compounds are used in combination. When a metal compound is used in combination with at least one mordant other than metal compounds among the mordant components described below, the mordant may be used in such an amount that the total content of the metal compound and the other mordants falls within the range specified above and that the effects of the invention are not impaired.

From the viewpoints of image density and ozone resistance, it is also preferable that the basic solution contains, as a metal compound, a magnesium salt such as those described above. The magnesium salt is particularly preferably magnesium chloride. When the magnesium salt is contained, the amount of the magnesium salt contained in the basic solution is preferably from 0.1% by mass to 1% by mass, and more preferably from 0.15% by mass to 0.5% by mass, with respect to total mass of the basic solution.

The basic solution may contain a crosslinking agent and/or another mordant component, if necessary.

The curing of the coating layer can be promoted by using the basic solution as an alkaline solution, and the basic solution preferably has a pH value of 7.1 or higher, more preferably 8.0 or higher, and still more preferably 9.0 or higher. When the pH value is 7.1 or higher, the crosslinking reaction of the water-soluble resin contained in the coating liquid can be further promoted.

The basic solution may be prepared, for example, by adding a metal compound (such as a zirconium compound) in an amount of, for example, from 1% to 5% and a basic compound (such as ammonium carbonate) in an amount of, for example, from 1% to 5%, and, optionally, paratoluenesulfonic acid in an amount of, for example, from 0.5% to 3%, to ion exchange water, and then thoroughly stirring them. The “%” value for each ingredient represents % by mass of solid of the ingredient with respect to the total mass of the basic solution.

The solvent used for the preparation of the basic solution may be water, an organic solvent or a mixture thereof. Examples of organic solvents which may be used include alcohols such as methanol, ethanol, n-propanol, i-propanol and methoxypropanol; ketones such as acetone and methyl ethyl ketone; tetrahydrofuran; acetonitrile; ethyl acetate; and toluene.

The content of inorganic particles, such as silica particles, in the basic solution is preferably small. The content of inorganic particles is preferably 5% by mass or less with respect to the total mass of the basic solution, and it is particularly preferable that the basic solution does not contain inorganic particles.

<Cooling Process and Drying Process>

The second method of forming an ink receiving layer includes a process (hereinafter sometimes referred to as a “cooling process”) whereby the coating layer formed through the coating layer formation process is cooled to a temperature that is at least 5° C. lower than the temperature of the coating liquid at the time of the application of the coating liquid, and a process (hereinafter sometimes referred to as a “drying process”) whereby the cooled coating layer is dried.

The method of cooling the coating layer in the cooling process is preferably a method of cooling the support, on which the coating layer is formed, in a cooling zone maintained at from 0° C. to 10° C. for 5 seconds to 30 seconds. In the cooling process, the support is preferably cooled to a temperature of from 0° C. to 10° C., and more preferably from 0° C. to 5° C.

Here, the temperature of the coating layer is obtained by measuring the temperature of the coating layer surface.

<Support>

The support may be a transparent support made of a transparent material such as plastic or an opaque support made of an opaque material such as paper. In order to utilize the transparency of the ink receiving layer, it is preferable to use a transparent support or a highly-glossy opaque support. Further, a read-only optical disk such as a CD-ROM or a DVD-ROM, a write-once optical disk such as a CD-R or a DVD-R, or a rewritable optical disk may be used as a support, and the ink receiving layer may be applied onto the label surface side thereof.

The material of the transparent support is preferably transparent and resistant to radiation heat when the inkjet recording medium is used on an OHP or a back light display. Examples of the material include polyesters such as polyethylene terephthalate (PET), polysulfone, polyphenylene oxide, polyimide, polycarbonate, and polyamide. Among them, polyesters are preferable, and polyethylene terephthalate is particularly preferable. The thickness of the transparent support has no particular limits, but it is preferably from 50 μm to 200 μm in view of easy-handling.

The high-gloss opaque support preferably has a glossiness of 40% or more on the surface on which the ink receiving layer is to be formed. The glossiness is a value determined by a method taught by JIS P-8142 (Testing Method for 75 Degree Specular Gloss of Paper and Paperboard), which is incorporated herein by reference.

Specific examples of the high-gloss opaque support include: high-gloss paper supports such as art paper, coated paper, cast-coated paper, and baryta paper commonly used as silver salt photographic supports; high-gloss films opacified by incorporating a white pigment or the like into plastic films such as polyesters such as polyethylene terephthalate (PET), cellulose esters such as nitrocellulose, cellulose acetate, and cellulose acetate butyrate, polysulfone, polyphenylene oxide, polyimide, polycarbonate, or polyamide, wherein the surface of the high-gloss films may be subjected to a calender treatment); and supports having a polyolefin coating layer containing, or not containing, a white pigment and formed on the surface of the various papers, the transparent supports, or the high-gloss films containing a white pigment.

Foamed polyester films containing a white pigment (for example, a foamed PET having voids formed by stretching a PET that contains polyolefin fine particles) are also favorable. Resin-coated papers commonly used as photographic papers for silver salt photographs are also preferable.

While the thickness of the opaque support is not particularly limited, it is preferably in a range of from 50 μm to 300 μm from the viewpoint of ease of handling.

The surface of the support may be subjected to corona discharge treatment, glow discharge treatment, flame treatment, ultraviolet ray irradiation treatment or the like for improvement in wetting properties and adhesive properties.

Then, base paper used in the resin coated papers is described in detail.

The main raw material of the base paper may be wood pulp. When making the base paper, at least one of a synthetic pulp or a synthetic fiber may be optionally used in addition to the wood pulp. The synthetic pulp may be made of, for example, polypropylene, and the synthetic fiber may be, for example, a nylon fiber or a polyester fiber. As the wood pulp, any of LBKP, LBSP, NBKP, NBSP, LDP, NDP, LUKP or NUKP may be used. It is preferable to increase the total amount of LBKP, NBSP, LBSP, NDP and LDP, which have high contents of short fibers. However, the proportion of LBSP and/or LDP is preferably from 10% by mass to 70% by mass.

The pulp is preferably a chemical pulp (such as sulfate salt pulp or sulfite pulp), which has a low impurity content. A pulp of which whiteness is improved by bleaching is also useful.

To the base paper, one or more of the following may be added as necessary: a sizing agent such as a higher fatty acid or an alkylketene dimer, a white pigment such as calcium carbonate, talc or titanium oxide, a paper-strength enhancing additive such as starch, polyacrylamide or polyvinyl alcohol, a fluorescent brightener, a moisturizing agent such as polyethylene glycol, a dispersant, a softener such as quaternary ammonium, or the like.

The freeness, according to CSF (Canadian Standard Freeness), of the pulp used for paper-making is preferably from 200 mL to 500 mL. In regard to the fiber length after beating, the total sum of the percent by mass of the pulp remaining on a 24-mesh screen and the percent by mass of the pulp remaining on a 42-mesh screen according to JIS P-8207 (which is incorporated herein by reference) is preferably from 30% to 70% by mass. Further, the percent by mass of the pulp remaining on a 4-mesh screen is preferably 20% by mass or less.

The basis weight of base paper is preferably from 30 g/m² to 250 g/m², particularly preferably from 50 g/m² to 200 g/m². The thickness of the base paper is preferably from 40 μm to 250 μm. High smoothness may be imparted to the base paper by subjecting the base paper to calender treatment during of after papermaking. The base paper density is generally from 0.7 g/m³ to 1.2 g/m³ (according to JIS P-8118, which is incorporated herein by reference).

Furthermore, the stiffness of the base paper is preferably from 20 g to 200 g under conditions defined by JIS P-8143, which is incorporated herein by reference.

The base paper surface may be coated with a surface sizing agent, which may be selected from the above-described sizes that may be incorporated into the interior of the base paper.

The pH of the base paper is preferably from 5 to 9 as measured according to the hydrothermal extraction method defined by JIS P-8113, which is incorporated herein by reference.

The polyethylene covering the front and rear surfaces of the base paper mainly includes a low-density polyethylene (LDPE) and/or a high-density polyethylene (HDPE), and optionally includes a small amount of other polymers such as LLDPE or polypropylene.

In particular, the polyethylene layer at a side on which the ink receiving layer is to be formed preferably includes at least one of rutile-titanium oxide, anatase-titanium oxide, a fluorescent brightener, or ultramarine, which are commonly used in photographic papers, whereby opacity, whiteness and hue are improved. The content of titanium oxide is preferably in a range of from about 3% by mass to about 20% by mass, and more preferably in a range of from 4% by mass to 13% by mass, with respect to the polyethylene. The thickness of each of the polyethylene layer on the front side and the polyethylene layer on the rear side is not particularly limited, but is preferably in a range of from 10 μm to 50 μm. In addition, an undercoat layer may be formed on the polyethylene layer for increasing the adhesion thereof to an ink receiving layer. The material of the undercoat layer preferably includes aqueous polyester, gelatin, or PVA. The thickness of the undercoat layer is preferably in a range of from 0.01 μm to 5 μm.

The polyethylene-coated paper may be glossy paper, or paper having a matte or silky surface that is similar to that of common photographic printing paper and that has been formed by performing surface-finishing treatment when coating polyethylene on base paper by melt-extrusion.

A backcoat layer may be provided on the support. The backcoat layer may be formed using a white pigment (for example, an inorganic pigment such as precipitated calcium carbonate, heavy calcium carbonate, kaolin, talc or calcium sulfate, or an organic pigment such as polyethylene or melamine resin), an aqueous binder (for example, a water-soluble polymer such as styrene/acrylic acid salt copolymer, polyvinyl alcohol, gelatin or polyvinyl pyrrolidone) and other components (for example, a defoaming agent, a foam-suppressing agent, a dye, a fluorescent brightener, an antiseptic agent, or a water-resistance agent).

The inkjet recording medium may further include at least one of an ink solvent absorbing layer, an intermediate layer or the like, in addition to the ink receiving layer. An undercoat layer may be formed on the support for the purposes of increasing the adhesiveness between the ink receiving layer and the support and of controlling the electric resistance appropriately.

A polymer fine-particle dispersion may be incorporated into a constituent layer (for example, the ink receiving layer or the backcoat layer) of the inkjet recording medium. This polymer fine-particle dispersion is used for the purpose of improving film properties, such as dimensional stability and anti-curling, anti-sticking and anti-cracking properties. Descriptions of the polymer fine-particle dispersion can be found, for example, in JP-A Nos. 62-245258 and 10-228076. Incorporation of a polymer fine-particle dispersion having a low glass transition temperature (40° C. or lower) into the above-described layer containing a mordant prevents cracking or curling of the layer. Incorporation of a polymer fine-particle dispersion having a high glass transition temperature into the backing layer also prevents curling.

The ink receiving layer may be provided at only one side of the support, or, alternatively, the ink receiving layer may be provided on each side of the support for the purpose of, for example, preventing deformation such as curling. When the ink receiving layer is provided on one side of the support for a recording medium used in OHP or the like, an anti-reflection layer may be provided at the opposite side of the support or at both sides of the support, for the purpose of enhancing light-transmitting property.

In an embodiment, boric acid or a boron compound is applied to a surface of the support on which an ink receiving layer is to be formed, and the ink receiving layer is formed thereon. As a result, the glossiness and/or the surface smoothness of the ink receiving layer can further be improved, and image bleed with the passage of time in high temperature and high humidity environments can be further suppressed.

˜Inkjet Recording Method˜

The inkjet recording method for recording an image on the inkjet recording medium of the present invention is not particularly limited. The inkjet recording method may be a known method such as a charge-control method in which ink is jetted by electrostatic attraction force; a drop-on-demand method (pressure-pulse method) in which a pressure of oscillation of a piezo element is utilized; an acoustic inkjet method in which ink is jetted by radiation pressure generated by irradiation of ink with acoustic beams that have been converted from electric signals; and a thermal inkjet method in which ink is jetted by a pressure generated by formation of bubbles caused by heating of ink. Examples of the inkjet recording method include a method in which a large number of small-volume droplets of an ink having a low optical density, which is called a photo ink, are jetted; a method in which plural inks of substantially the same hue at different densities are used to improve image quality; and a method in which a clear and colorless ink is used.

### EXAMPLES

In the following, the present invention is explained in further detail with reference to examples; however, the present invention is not in any way limited to these Examples. Moreover, the term “part(s)” refers to “part(s) by mass” unless otherwise noted.

### Example 1

—Production of Pre-Dispersion Liquid—

1.76 kg of vapor-phase process silica AEROSIL 300 SF75 (trade name, manufactured by Nippon Aerosil Co., Ltd.; average primary diameter: 7 nm) were added to 20.5 kg of ion exchange water (medium), and 0.15 kg of SHAROL DC-902P (trade name, dispersant, manufactured by Dai-ichi Kogyo Seiyaku Co., Ltd.) were further added thereto, thereby providing a mixed liquid. The mixed liquid was subjected to a dispersing treatment using a pre-dispersion-liquid producing apparatus PSI-MIX•MICRO PSI (trade name, manufactured by Ashizawa Finetech Ltd.) under the conditions described below (the same conditions were employed in the following descriptions). After the dispersing treatment, the pressure was reduced by 9.0×10⁴ Pa and was maintained at that pressure for 5 minutes.

Thereafter, 1.76 kg of AEROSIL 300 SF75 (trade name, manufactured by Nippon Aerosil Co., Ltd.) were added thereto, and then 0.15 kg of SHAROL DC-902P (trade name, dispersant, manufactured by Dai-ichi Kogyo Seiyaku Co., Ltd.) were further added thereto. The resultant mixed liquid was subjected to a dispersing treatment using the PSI-MIX•MICRO PSI, and, thereafter, the pressure was again reduced by 9.0×10⁴ Pa and maintained at that pressure for 5 minutes. Further, 1.76 kg of AEROSIL 300 SF75 (trade name, manufactured by Nippon Aerosil Co., Ltd.) were added thereto, and 0.31 kg of SHAROL DC-902P (trade name, dispersant, manufactured by Dai-Ichi Kogyo Seiyaku Co., Ltd.) were further added thereto. The resultant mixture liquid was again subjected to a dispersing treatment using the PSI-MIX•MICRO PSI, and, thereafter, the pressure was again reduced by 9.0×10⁴ Pa and maintained at that pressure for 5 minutes. Subsequently, 1.76 kg of AEROSIL 300 SF75 (trade name, manufactured by Nippon Aerosil Co., Ltd.) were added thereto, and the resultant mixture liquid was subjected to a dispersing treatment using the PSI-MIX•MICRO PSI. Thereafter, the pressure was again reduced by 9.0×10⁴ Pa and maintained at that pressure for 5 minutes.

### <Dispersing Conditions>

### Number of Revolutions: 2,500 rpm

Applied pressure: 9.0 MPa
Circulation quantity of dispersion: 10 L/minute

In the above manner, a pre-dispersion liquid of vapor-phase process silica was produced.

Evaluation and Measurement—

(1) Measurement of Liquid Viscosity

The temperature of the obtained pre-dispersion liquid was adjusted to 30° C., and the viscosity (Pa·s) of the pre-dispersion liquid was measured by using a B-type viscometer (manufactured by Toki Sangyo Co., Ltd.) while maintaining the temperature at 30° C. The measurement results are shown in Table 1.

—Preparation of Coating Liquid for Forming Ink Receiving Layer—

0.47 parts of zirconyl acetate (ZIRCOSOL ZA-30 (trade name), 50% solution, manufactured by Daiichi Kigenso Kagaku Kogyo Co., Ltd.) was mixed with 35.7 parts of the obtained pre-dispersion liquid. The mixture was dispersed using a liquid-liquid collision dispersing machine (ULTIMIZER (trade name) manufactured by Sugino Machine Limited), and then the obtained dispersion liquid was heated to 45° C. and maintained at that temperature for 20 hours. Thereafter, 31.6 parts of ion exchange water, 4.4 parts of a 7.5% aqueous boric acid solution (crosslinking agent), 0.1 parts of dimethylamine epichlorohydrin polyalkylene-polyamine polycondensate (50% solution, SC-505 (trade name) manufactured by Hymo Co., Ltd.), 26.0 parts of the polyvinyl alcohol solution described below, and 2.2 parts of a cation-modified polyurethane (SUPERFLEX650-5 (trade name), 25% aqueous solution, manufactured by Dai-ichi Kogyou Seiyaku Co., Ltd.) were added to the dispersion liquid, and the resultant mixture was stirred using a dissolver at a number of revolutions of 8,000 rpm for 10 minutes. Thereafter, a solution containing 1.2 parts of polyoxyethylene lauryl ether (EMULGEN 109P (trade name), HLB value: 13.6, 10% by mass aqueous solution, manufactured by Kao Corporation), and 33.0 parts of ion exchange water were added thereto, and the resultant mixture was again stirred using a dissolver at a number of revolutions of 2,000 rpm for 10 minutes. In this way, a coating liquid A for forming an ink receiving layer was prepared.

### <Composition of Polyvinyl Alcohol Solution>

| | |
|---|---|
| Polyvinyl alcohol (JM-33 (trade name), | 6.96 parts |
| saponification degree: 94.3 mol %; polymerization degree: | |
| 3,300, manufactured by Japan Vam & Vobal Co., Ltd.) | |
| Polyoxyethylene lauryl ether | 0.23 parts |
| (surfactant, EMULGEN 109P (trade name) | |
| manufactured by Kao Corporation) | |
| Diethyleneglycol monobutyl ether | 2.12 parts |
| (BUTYCENOL 20P (trade name) | |
| manufactured by Kyowa Hakkou Kogyo Co., Ltd.) | |
| Ion exchanged water | 90.69 parts |

Preparation of InkJet Recording Sheet—

First, a support was prepared in the following manner.

Wood pulp including 100 parts of LBKP was beaten to a Canadian freeness of 300 ml in a double disk refiner, and 0.5 parts of epoxidized behenic acid amide, 1.0 part of an anionic polyacrylamide, 0.1 parts of polyamide polyamine epichlorohydrin and 0.5 parts of a cationic polyacrylamide were added thereto (the amounts being based on bone-dry mass ratio relative to the pulp), and a base paper having a basis weight of 170 g/m² was made using a Fourdrinier paper machine.

In order to adjust the surface sizing of the obtained base paper, the base paper was impregnated with a solution obtained by adding 0.04% by mass of a fluorescent brightener (WHITEX BB, trade name, manufactured by Sumitomo Chemical Co., Ltd.) to a 4% by mass of aqueous polyvinyl alcohol solution, and was dried, such that the impregnation amount was 0.5 g/m² in terms of bone dry weight. Thereafter, the base paper was further subjected to a calender treatment to form a base paper having a density of 1.05.

After the wire surface (rear surface) of the obtained base paper was subjected to a corona discharge treatment, the surface was coated with a high density polyethylene to a thickness of 19 μm using a melt extruder to form a resin layer with a matt surface (hereinafter, this resin-coated surface is referred to as a “rear surface”). The resin layer at the rear surface was further subjected to a corona discharge treatment. Thereafter, the resin layer at the rear surface was coated with a dispersion liquid in which aluminum oxide (ALUMINASOL 100 (trade name), manufactured by Nissan Chemical Industries, Ltd.) as an antistatic agent and silicon dioxide (SNOWTEX O (trade name), manufactured by Nissan Chemical Industries, Ltd.) at a mass ratio of 1:2 were dispersed in water, at an amount that corresponds to a dry weight of 0.2 g/m².

After the felt surface (front surface), on which the resin layer was not formed, of the base paper was subjected to a corona discharge treatment, a low-density polyethylene with a MFR (melt-flow rate) of 3.8 containing 10% by mass of anatase titanium dioxide, a trace amount of ultramarine blue and 0.01% by mass of a fluorescent brightener (with respect to polyethylene) was melt-extruded from a melt-extruder to a thickness of 29 μm, thereby forming a high-glossy thermoplastic resin layer on the front surface of the base paper (hereinafter, the high-glossy surface is referred to as the “front surface”).

In this way, a support was prepared.

The front surface of the obtained support was subjected to a corona discharge treatment. Thereafter, the coating liquid A for forming an ink receiving layer and the following PAC liquid were in-line blended, and the blended liquid was applied onto the front surface using an extrusion die coater such that the coating amount of the coating liquid A was 183 g/m² and the coating amount of the PAC liquid was 11.4 g/m². Thereafter, the coating layer was dried at 80° C. using a heat blow-drier (at an air flow rate of from 3 to 8 m/second) until the solid concentration of the coating layer became 20% by mass. During this period, the coating layer showed a constant-rate drying. Before the coating layer showed a falling-rate drying, the coating layer was immersed in the following basic solution (pH: 7.8) for 3 seconds, so that the solution in an amount of 13 g/m² was adhered onto the coating layer, and the layer was dried at 65° C. for 10 minutes.

In this way, an inkjet recording sheet that has an ink receiving layer having a dry thickness of 32 μm was prepared.

<Composition of PAC Liquid 1>

| | |
|---|---|
| Polyaluminum chloride aqueous solution having | 20 parts |
| a basicity of 83% (ALUFINE 83, trade name, | |
| manufactured by Daimei Chemicals Co., Ltd.) | |
| Ion exchange water | 80 parts |

<Composition of Basic Solution>

| | |
|---|---|
| Boric acid | 0.65 parts |
| Ammonium zirconium carbonate ((28% by mass | 0.33 parts |
| aqueous solution), ZIRCOSOL AC-7, trade name, | |
| manufactured by Daiichi Kigenso Kagaku Kogyo Co., Ltd.) | |
| Ammonium carbonate ((first grade, manufactured by | 3.5 parts |
| Kanto Chemical Co., Ltd.) | |
| Ion exchanged water | 63.3 parts |
| Polyoxyethylene lauryl ether (surfactant, EMULGEN 109P | 30.0 parts |
| (trade name) manufactured by Kao Corporation, | |
| 2% by mass aqueous solution) | |

—Evaluation of Ink Absorptivity—

Using an inkjet printer (PM-A820C (trade name) manufactured by Seiko Epson Corporation), solid images of Y (yellow), M (magenta), C (cyan), K (black), B (blue), G (green) and R (red) were printed on the prepared inkjet recording sheet. Immediately thereafter (about 10 seconds after printing), a blank sheet was superposed on the printed solid image areas and was pressed thereagainst, and observation was made to determine whether ink was transferred to the blank sheet. The ink absorptivity was evaluated in accordance with the following evaluation criteria using the degree of ink transfer as an index.

### <Evaluation Criteria>

A: Ink is not transferred to the sheet at all, and ink absorptivity is favorable
B: Ink is slightly transferred to the sheet
C: Ink is partly transferred to the sheet

### Example 2

A pre-dispersion liquid was produced and the viscosity of the pre-dispersion liquid and the particle diameter were measured in the same manner as in Example 1, except that the pressure reduction in the production of the pre-dispersion liquid was changed from 9.0×10⁴ Pa to 5.0×10⁴ Pa. Further, a coating liquid for forming an ink receiving layer was prepared and an inkjet recording sheet was produced and evaluated, in the same manner as in Example 1 except for using the pre-dispersion liquid obtained above in place of the pre-dispersion liquid of Example 1.

### Example 3

A pre-dispersion liquid was produced and the viscosity of the pre-dispersion liquid and the particle diameter were measured in the same manner as in Example 1, except that the addition of each of the vapor-phase process silica and the dispersant was performed only once as described below, rather than in more than one stage. Further, a coating liquid for forming an ink receiving layer was prepared and an inkjet recording sheet was produced and evaluated, in the same manner as in Example 1 except for using the pre-dispersion liquid obtained above in place of the pre-dispersion liquid of Example 1.

### —Production of Pre-Dispersion Liquid—

A mixed liquid was obtained by adding 0.61 kg of SHAROL DC-902P (trade name, dispersant, manufactured by Dai-ichi Kogyo Seiyaku Co., Ltd.) to 20.5 kg of ion exchanged water (medium) and further adding thereto 7.04 kg of vapor-phase process silica AEROSIL 300 SF75 (trade name, manufactured by Nippon Aerosil Co., Ltd., average primary diameter: 7 nm). The mixed liquid was subjected to a dispersing treatment using a pre-dispersion-liquid producing apparatus PSI-MIX•MICRO PSI (trade name, manufactured by Ashizawa Finetech Ltd.). After the dispersing treatment, the pressure was reduced by 9.0×10⁴ Pa and was maintained at that pressure for 5 minutes, as a result of which a pre-dispersion liquid of vapor-phase process silica was obtained.

### Example 4

A pre-dispersion liquid was produced in a manner similar to the production of a pre-dispersion liquid in Example 1, except that the addition of each of the vapor-phase process silica particles and the dispersant was performed in more than one stage as described below. The viscosity of the pre-dispersion liquid and the particle diameter were measured in a manner similar to Example 1. Further, a coating liquid for forming an ink receiving layer was prepared and an inkjet recording sheet was produced and evaluated, in the same manner as in Example 1 except for using the pre-dispersion liquid obtained above in place of the pre-dispersion liquid of Example 1.

—Production of Pre-Dispersion Liquid—

A mixed liquid was obtained by adding 3.52 kg of vapor-phase process silica AEROSIL 300 SF75 (trade name, manufactured by Nippon Aerosil Co., Ltd., average primary diameter: 7 nm) to 20.5 kg of ion exchanged water (medium) and further adding 0.30 kg of SHAROL DC-902P (trade name, dispersant, manufactured by Dai-ichi Kogyo Seiyaku Co., Ltd.) thereto. The mixed liquid was subjected to a dispersing treatment using a pre-dispersion-liquid producing apparatus PSI-MIX•MICRO PSI (trade name, manufactured by Ashizawa Finetech Ltd.). After the dispersing treatment, the pressure was reduced by 9.0×10⁴ Pa and was maintained at that temperature for 5 minutes.

Further, 1.76 kg of AEROSIL 300 SF75 (trade name, manufactured by Nippon Aerosil Co., Ltd.) were added to the dispersion liquid, and 0.31 kg of SHAROL DC-902P (trade name, dispersant, manufactured by Dai-ichi Kogyo Seiyaku Co., Ltd.) were further added thereto. The resultant mixture liquid was subjected to a dispersing treatment using the PSI-MIX•MICRO PS. Thereafter, the pressure was again reduced by 9.0×10⁴ Pa and was maintained at that pressure for 5 minutes. Subsequently, 1.76 kg of AEROSIL 300 SF75 (trade name, manufactured by Nippon Aerosil Co., Ltd.) were added thereto, and the resultant mixture liquid was subjected to a dispersing treatment using the PSI-MIX•MICRO PSI. Then, the pressure was again reduced by 9.0×10⁴ Pa and was maintained at that temperature for 5 minutes.

In this way, a pre-dispersion liquid of vapor-phase process silica was produced.

### Comparative Example 1

A pre-dispersion liquid was produced in the same manner as in Example 1, except that the pre-dispersion-liquid producing apparatus (PSI-MIX•MICRO PSI) used in the production of the pre-dispersion liquid of Example 1 was replaced by a suction dispersion mixer CONTI-TDS (trade name, manufactured by Ystral GmbH), and that the pressure reduction was not performed after the dispersing treatment. The viscosity of the pre-dispersion liquid and the particle diameter were measured, a coating liquid for forming an ink receiving layer was produced, and an inkjet recording sheet was produced and evaluated, in the same manner as in Example 1 except for using the pre-dispersion liquid obtained above in place of the pre-dispersion liquid of Example 1.

### Comparative Example 2

A pre-dispersion liquid was produced in the same manner as in Example 1, except that the pre-dispersion-liquid producing apparatus (PSI-MIX•MICRO PSI) used in the production of the pre-dispersion liquid of Example 1 was replaced by T.K. ROBOMIX (trade name, manufactured by Primix Corporation), and that the pressure reduction was not performed. The viscosity of the pre-dispersion liquid and the particle diameter were measured, a coating liquid for forming an ink receiving layer was produced, and an inkjet recording sheet was produced and evaluated, in the same manner as in Example 1 except for using the pre-dispersion liquid obtained above in place of the pre-dispersion liquid of Example 1.

TABLE 1

| | | Method of Addition | | | | | |
|---|---|---|---|---|---|---|---|
| | Total Amount | Number of | | | | | |
| | of Silica in | Addition | | | | | |
| | Terms of Solid | (Pigment/ | Initially Added | | Pressure Reduction [Pa] | Viscosity of | |
| | Content (mass | Dispersant) | Solid Amount | Dispersing | When Maintaining | Pre-dispersion | Ink |
| | basis) | (mass basis) | (mass basis) | Machine | Reduced Pressure | Liquid [Pa · s] | Absorptivity |
| Example 1 | 25% | Four times/ | 6.3% | PSI-MIX | 9.0 × 10⁴ | 0.6 | A |
| | | Three times | | | | | |
| Example 2 | 25% | Four times/ | 6.3% | PSI-MIX | 5.0 × 10⁴ | 0.8 | A |
| | | Three times | | | | | |
| Example 3 | 25% | Once | 25% | PSI-MIX | 9.0 × 10⁴ | 1.0 | A |
| Example 4 | 25% | Three times/ | 12.5% | PSI-MIX | 9.0 × 10⁴ | 0.8 | A |
| | | Twice | | | | | |
| Comparative | 25% | Four times/ | 6.3% | Conti-TDS | Unmeasurable | Unable to add | — |
| Example 1 | | Three times | | | | powder | |
| Comparative | 25% | Four times/ | 6.3% | T.K. | 0 | Unable to add | — |
| Example 2 | | Three times | | ROBOMIX | | powder | |

As shown in Table 1, an increase in viscosity of the dispersion liquid was suppressed and favorable dispersibilty was achieved in the Examples even though the amount of the silica fine particles in terms of solid content was as high as 25%. Further, inkjet recording sheets prepared using the dispersion liquids of the Examples had excellent ink absorptivity.

In contrast, in the Comparative Examples, in which a depressurization process was not performed after dispersing, the viscosity drastically increased as the solid content increased by adding portions of silica fine particles in more than one stage, as a result of which it was not possible to add all of the desired amount of silica particles. Therefore, dispersing could not be performed satisfactorily, and increase of the concentration of the silica particles could not be attained.

The invention provides a method of producing a white pigment dispersion liquid whereby the pigment concentration in terms of solid concentration can be increased while suppressing an increase in viscosity, and also provides a method of producing an inkjet recording medium whereby a dispersion liquid can be supplied efficiently during the preparation of a coating liquid for forming an inkjet recording medium, coating defects can be suppressed, and an inkjet recording medium having high density, favorable glossiness and favorable ink absorptivity can be obtained.

Embodiments of the present invention include, but are not limited to, the following.

<1> A method of producing a white pigment dispersion liquid, the method comprising:
mixing and dispersing a white pigment, a dispersant and a medium to form a dispersion liquid in which the amount of the white pigment is 20% by mass or more relative to the total mass of the dispersion liquid; and
subjecting the dispersion liquid to a depressurization treatment after the dispersing.
   <2> The method of producing a white pigment dispersion liquid according to <1>, wherein the average primary particle diameter of the white pigment is 20 nm or less.
   <3> The method of producing a white pigment dispersion liquid according to <1> or <2>, wherein the white pigment comprises vapor-phase process silica.
   <4> The method of producing a white pigment dispersion liquid according to any one of <1> to <3>, wherein the depressurization treatment is performed by reducing the pressure by 1×10⁴ Pa or more.
   <5> The method of producing a white pigment dispersion liquid according to any one of <1> to <4>, wherein the dispersant is a cationic compound.
   <6> The method of producing a white pigment dispersion liquid according to <5>, wherein the cationic compound comprises a diallyldimethyl cationic polymer.
   <7> The method of producing a white pigment dispersion liquid according to any one of <1> to <6>, wherein each of the white pigment and the dispersant is added in more than one stage.
   <8> The method of producing a white pigment dispersion liquid according to any one of <1> to <7>, wherein the ratio of the dispersant to the white pigment is from 0.1% by mass to 30% by mass.
   <9> The method of producing a white pigment dispersion liquid according to any one of <1> to <8>, wherein the medium includes an aqueous medium and the aqueous medium includes water or a mixed medium of water and an organic solvent that is miscible with water.
   <10> The method of producing a white pigment dispersion liquid according to any one of <1> to <9>, wherein the duration of the depressurization treatment is 3 minutes or more.
   <11> A method of producing an inkjet recording medium comprising:
producing a white pigment dispersion liquid by the method of producing a white pigment dispersion liquid according to any one of <1> to <10>;
preparing a coating liquid by mixing at least the white pigment dispersion liquid and a water-soluble resin; and
forming an ink receiving layer by applying the coating liquid onto a support.
   <12> The method of producing an inkjet recording medium according to <11>, wherein the water-soluble resin comprises a polyvinyl alcohol resin.
   <13> The method of producing an inkjet recording medium according to <11> or <12>, wherein the content of the water-soluble resin is from 9% by mass to 40% by mass relative to a total solid content of the coating liquid or of the ink receiving layer.
   <14> The method of producing an inkjet recording medium according to any one of <11> to <13>, wherein the white pigment includes vapor-phase process silica, and the mass ratio of the vapor-phase process silica (x) to the water-soluble resin (y) [PB ratio(x/y)] is from 1.5/1 to 10/1.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of producing a white pigment dispersion liquid, the method comprising:
mixing and dispersing a white pigment, a dispersant and a medium to form a dispersion liquid in which the amount of the white pigment is 20% by mass or more relative to the total mass of the dispersion liquid; and
subjecting the dispersion liquid to a depressurization treatment after the dispersing.

2. The method of producing a white pigment dispersion liquid according to claim 1, wherein the average primary particle diameter of the white pigment is 20 nm or less.

3. The method of producing a white pigment dispersion liquid according to claim 1, wherein the white pigment comprises vapor-phase process silica.

4. The method of producing a white pigment dispersion liquid according to claim 1, wherein the depressurization treatment is performed by reducing the pressure by 1×10⁴ Pa or more.

5. The method of producing a white pigment dispersion liquid according to claim 1, wherein the dispersant is a cationic compound.

6. The method of producing a white pigment dispersion liquid according to claim 5, wherein the cationic compound comprises a diallyldimethyl cationic polymer.

7. The method of producing a white pigment dispersion liquid according to claim 1, wherein each of the white pigment and the dispersant is added in more than one stage.

8. The method of producing a white pigment dispersion liquid according to claim 1, wherein the ratio of the dispersant relative to the white pigment is from 0.1% by mass to 30% by mass.

9. The method of producing a white pigment dispersion liquid according to claim 1, wherein the medium comprises an aqueous medium and the aqueous medium comprises water or a mixed medium of water and an organic solvent that is miscible with water.

10. The method of producing a white pigment dispersion liquid according to claim 1, wherein the duration of the depressurization treatment is 3 minutes or more.

11. A method of producing an inkjet recording medium comprising:
producing a white pigment dispersion liquid by the method of producing a white pigment dispersion liquid according to claim 1;
preparing a coating liquid by mixing at least the white pigment dispersion liquid and a water-soluble resin; and
forming an ink receiving layer by applying the coating liquid onto a support.

12. The method of producing an inkjet recording medium according to claim 11, wherein the water-soluble resin comprises a polyvinyl alcohol resin.

13. The method of producing an inkjet recording medium according to claim 11, wherein the content of the water-soluble resin is from 9% by mass to 40% by mass relative to a total solid content of the coating liquid or of the ink receiving layer.

14. The method of producing an inkjet recording medium according to claim 11, wherein the white pigment comprises vapor-phase process silica, and the mass ratio of the vapor-phase process silica (x) to the water-soluble resin (y) [PB ratio(x/y)] is from 1.5/1 to 10/1.
